(19) United States
(12) Patent Application Publication
(10) Pub. No.: US 2004/0070819 A1
(43) Pub. Date: Apr. 15, 2004

(54) Broadband tunable optical amplifier

(75) Inventors: Kevin S. Farley, Ottawa (CA); Nigel Jolley, Herts (GB)

Correspondence Address: DOWELL & DOWELL PC, SUITE 309, 1215 JEFFERSON DAVIS HIGHWAY, ARLINGTON, VA, 22202

(73) Assignee: NORTEL NETWORKS LIMITED

(21) Appl. No.: 10/268,772

(22) Filed: Oct. 11, 2002

(51) Int. Cl. H01S 3/00

(52) U.S. Cl. 359/341.4

(57) ABSTRACT

An optical amplifier for amplifying an optical signal along a transmission path. The optical amplifier includes a tunable pump source that provides optical energy to a gain medium arranged along the transmission path and the tunable pump source can be tuned in at least frequency to provide controlled or optimized amplification of the optical signal. In particular, the frequency of the tunable pump source may be controlled based on a detected characteristic of the optical signal and/or may also be controlled to periodically vary, either continuously or discretely, over a pump frequency range that is related to an optical signal frequency range of the optical signal. In a particular case, the pump frequency range may be related to the optical signal frequency range in such a way that the tunable pump source provides Raman amplification over the optical signal frequency range.

### FIELD OF THE INVENTION

The present invention relates to optical amplifiers, and more particularly to broadband Raman amplifiers utilizing a tunable laser.

### BACKGROUND OF THE INVENTION

Optical communication systems are used extensively in data communications systems and networks, including telephone, cable and computer networks. Optical communication systems use optical fibers to carry light signals that, in turn, carry information. The information that is carried may consist of voice, audio, video, or any other format of data.

In early optical communication systems, an optical signal carrying a single stream of data was sent through a single optical fiber. In order to allow a larger amount of data to be transmitted, channels of data could be time division multiplexed (TDM) on the optical signal. More recently, wavelength division multiplexing (WDM) has been used to allow a single fiber to carry multiple optical signals simultaneously, each at a different wavelength. Predetermined wavelengths are used for each of the multiple optical signals in WDM. Typically these predetermined wavelengths are set by international standards bodies such as the International Telecommunications Union (ITU) and may be selected depending on the needs of a particular optical communications system. For example, ITU Recommendation ITU-T G.692 specifies a grid of wavelengths for use in WDM.

Often an optical communication system will span long distances between transmitters and receivers. As such, it is often necessary to amplify the optical signals at points on the signal transmission path so that the optical signals will remain strong enough for accurate reception upon reaching their destination.

In the past, amplification was performed by converting the optical signals to electrical signals and then regenerating optical signals having the desired amplitudes from the electrical signals. More recently, “optical amplifiers” have been developed which allow an optical signal to be amplified directly without conversion to an electrical signal.

One such optical amplifier is the Raman amplifier. A Raman amplifier relies on stimulated Raman scattering for amplification of an optical signal. Stimulated Raman scattering occurs when an intense pump beam or signal propagates through silica fibers. In particular, Raman scattering is a scattering process in which an incident pump photon loses a portion of its energy to a molecule in the fiber medium, creating another photon of reduced energy at a lower frequency, called a Stokes frequency. The Stokes frequency will be dependent on the pump signal and the characteristics of the gain medium. An optical signal propagating in the fiber together with the pump signal at or near the Stokes frequency will be coupled to the photons emitted as a result of the Raman scattering and amplified. As such, a pumping energy of a given wavelength amplifies an optical signal at a longer wavelength.

In Raman amplifiers, the relationship among the pump signal, the optical signal and the gain can vary greatly depending on the parameters or properties of the optical communications system, for example, the optical frequencies in use for both the pump signal and the optical signal, distances, relative propagation direction of pump and signal, polarization alignment of signal and pump (pump is usually depolarized) and power of the pump and optical signal, as well as on the physical properties or parameters of the optical fiber (gain medium) that is being used, for example, Raman gain coefficient fiber loss, cross-section of the pump beam in the fiber, or the like. Further, although stimulated Raman scattering occurs across a relatively broad range of pumping frequencies, the actual bandwidth of the Raman gain for a given pumping frequency is somewhat limited.

As such, it has generally been necessary to manufacture Raman amplifiers that are specific to the parameters of a particular system. This has required manufacturers to produce a wide variety of optical amplifiers at various pumping frequencies for use with various combinations of optical signals and gain media.

The use of WDM has also made it somewhat more difficult to amplify optical signals directly, because conventional Raman optical amplifiers produce amplification only over a limited frequency range for a given pumping frequency. Nevertheless, attempts have been made to use a plurality of pumping lasers, each operating at a single frequency, to amplify a broader range of frequencies of optical signals. However, because of the range of frequencies and types of optical fiber used in WDM systems, it remains necessary to manufacture a wide variety of optical amplifiers for different combinations of frequencies and types of optical fiber. Further, the use of multiple pump sources may result in uneven gain (gain ripple) across a desired frequency range and it can also be difficult to arrange the frequencies of the plurality of pump sources to minimize unwanted interactions between the pump signal frequencies, such as, for example, four wave mixing and Raman amplification of one pump signal by other higher frequency pump signals.

Accordingly, there is a need for an improved optical amplifier that will provide amplification across a wider range of frequencies while avoiding or reducing some of the difficulties associated with gain ripple and pump to pump interaction.

### SUMMARY OF THE INVENTION

It is therefore an object of this invention to provide an improved optical amplifier that addresses at least some of the problems identified above.

Accordingly, according to an embodiment of the invention, there is provided an optical amplifier for amplifying an optical signal along a transmission path. The optical amplifier includes a tunable pump source that provides optical energy to a gain medium arranged along the transmission path and the tunable pump source can be tuned in at least frequency to provide controlled or optimized amplification of the optical signal. In particular, the frequency of the tunable pump source may be controlled based on a detected characteristic of the optical signal and/or may also be controlled to periodically vary, either continuously or discretely, over a pump frequency range that is related to an optical signal frequency range of the optical signal. In a particular case, the pump frequency range may be related to the optical signal frequency range in such a way that the tunable pump source provides Raman amplification over the optical signal frequency range.

According to another embodiment of the invention, there is provided an optical amplifier for amplifying an optical signal along a transmission path. The amplifier includes: a tunable pump laser, tunable over a predetermined frequency range; a gain medium along the transmission path; a coupler for optically coupling the tunable laser to the gain medium; a detector to detect at least one characteristic of the optical signal; an optical splitter to provide at least a portion of the optical signal to the detector; and a controller for controlling a frequency of the tunable pump laser, the controller in communication with the detector and operable to control the frequency of the tunable pump laser based on the at least one characteristic to provide controlled amplification of the optical signal.

In a particular case, the controller may further control an operating power of the tunable pump laser.

In another particular case, the optical signal may be a plurality of optical signals at different frequencies within an optical signal frequency range, and in this case, the controller may be further operable to periodically vary a frequency of the tunable pump source over a pumping frequency range related to the optical signal frequency range. In particular, the frequency of the tunable pump source may be varied over the pumping frequency range (between a lower frequency bound and an upper frequency bound) either continuously or in discrete steps related to the different frequencies of the plurality of optical channels. Again, the control system may also control a power of the tunable pump source to provide optimal amplification to the optical signals based on the at least one characteristic.

In another particular case, the gain medium may comprise silica optical fiber. In this case, the optical fiber may connect a transmitter and a receiver in an optical communications system.

According to another embodiment of the invention, there is provided an optical amplifier for amplifying optical signals along a transmission path. The optical amplifier includes: a tunable laser, tunable over at least a scanning frequency range that is related to amplification of frequencies of the optical signals; a gain medium along the transmission path, for receiving optical energy from the tunable laser and providing the optical energy to the optical signals; a coupler for coupling the tunable laser to the gain medium; and a control system for controlling a frequency of the tunable laser to periodically scan over the scanning frequency range.

In a particular case, the control system may control the tunable pump source to periodically scan over the scanning frequency range either continuously or in discrete steps that are related to the frequencies of the optical signals. Further, the control system may also control a power of the tunable pump source to provide optimal amplification to the optical signals.

In another particular case, the control system may include: an optical splitter for splitting off a portion of the optical signals; a detector for detecting the frequencies of the optical signals; a controller for determining the scanning frequency range for the tunable laser based on the frequencies of the optical signals and for controlling the frequency of the tunable laser.

According to another embodiment of the invention, there is provided a method of optically amplifying optical signals. The method includes: determining frequencies of at least selected signals of the optical signals; determining a pumping frequency range for amplifying the selected signals; and controlling a tunable pump source optically connected with the optical signals to periodically scan over the pumping frequency range.

In a particular case, the controlling may involve controlling the tunable pump source to periodically scan across the pumping frequency range continuously or in discrete steps that are related to the frequencies of the selected signals.

The method according to this embodiment may further involve detecting at least one characteristic of the optical signals and the controlling may further involve also tuning pump power to optimize the at least one characteristic of the optical signals. In particular, the at least one characteristic of the optical signals may be a known or hereafter know characteristic of optical signals, and may include, for example, power, frequency, gain, signal-to-noise ratio, bit error rate, or quality.

According to another embodiment of the invention, there is provided an optical amplifier for amplifying an optical signal along a transmission path, in which the amplifier includes: a first tunable laser, which is tunable over a first predetermined frequency range; a second tunable laser, which is tunable over a second predetermined frequency range; a gain medium along the transmission path; a coupler for optically coupling the first tunable laser and the second tunable laser to the gain medium; a detector to detect at least one characteristic of the optical signal; an optical splitter to provide at least a portion of the optical signal to the detector; and a controller for controlling frequencies of the first tunable laser and the second tunable laser, the controller in communication with the detector and operable to control the frequencies of the first tunable laser and the second tunable laser based on the at least one characteristic to provide controlled amplification of the optical signal.

In a particular case, the controller may further control an operating power of the first tunable laser and the second tunable laser.

According to another embodiment of the invention, there is provided a computer readable medium containing computer executable instructions for optically amplifying optical signals, which, when operating in a processor, cause the processor to perform the functions of: determining frequencies of at least selected signals of the optical signals; determining a pumping frequency range for amplifying the selected signals; and controlling a tunable pump source optically connected with the optical signals to periodically scan over the pumping frequency range.

In a particular case, the controlling may include controlling the tunable pump source to periodically scan across the pumping frequency range in discrete steps that are related to the frequencies of the selected signals.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 shows a basic optical communication system with optical amplifiers;

FIG. 2 shows an optical amplifier according to an embodiment of the invention;

FIG. 3 illustrates a Raman gain spectrum for a conventional raman pump laser at a pump frequency f0;

FIG. 4 illustrates a gain spectrum for the optical amplifier of FIG. 2 when discretely scanning a pumping energy frequency;

FIG. 5 illustrates a gain spectrum for the optical amplifier of FIG. 2 when continuously scanning a pumping energy frequency;

FIG. 6 is a flowchart illustrating an example operation of a controller of the optical amplifier of FIG. 2; and

FIG. 7 shows an optical amplifier according to another embodiment of the invention.

### DETAILED DESCRIPTION

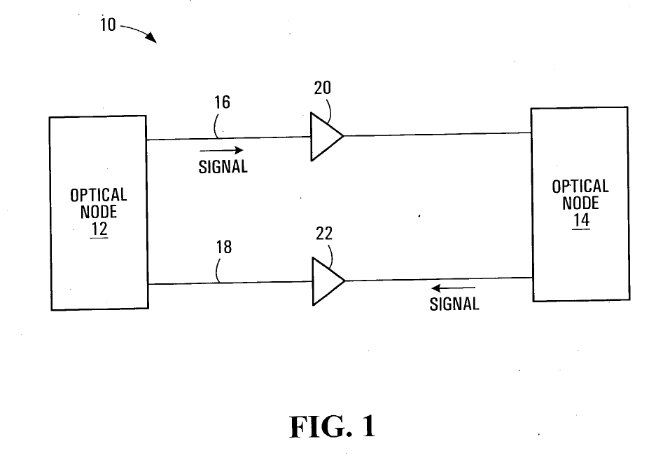

FIG. 1 shows a basic optical communication system 10, which includes nodes 12 and 14. Nodes 12 and 14 are interconnected by fibers 16 and 18, each defining a transmission path between these nodes. As will be understood, nodes 12 and 14 act as both transmitters and receivers of optical signals. Optical amplifiers 20 and 22 are provided along the transmission paths (i.e. along optical fibers 16 and 18) between nodes 12 and 14 in order to maintain the strength of optical signals along the transmission paths. In FIG. 1, only one pair of nodes 12 and 14, fibers 16 and 18, and optical amplifiers 20 and 22 is depicted for clarity. However, it will be understood by those skilled in the art that the embodiments of the present invention are applicable to optical networks that include many nodes and many transmission paths having different lengths that may require a plurality of optical amplifiers along their lengths.

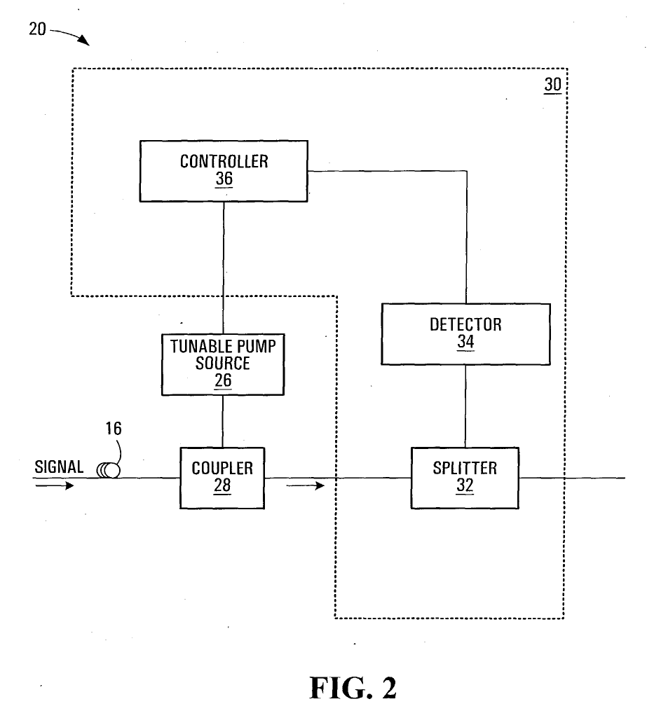

Optical amplifier 20, which is exemplary of an embodiment of the invention, is shown in greater detail in FIG. 2. Optical amplifier 22 (FIG. 1) is similar to optical amplifier 20 and, as such, only the structure and operation of optical amplifier 20 will be described. In the example embodiment, optical amplifier 20 is a distributed amplifier, which makes use of at least a portion of optical fiber 16 of the transmission path as a gain medium to generate an optical gain. The portion of optical fiber 16 used to generate gain may vary in length and may be limited, for example, to a small section of the transmission path or may alternatively, encompass the entire length of the transmission path. Alternatively, it will be understood by one of skill in the art that optical amplifier 20 may also be a discrete or “lumped” amplifier which uses a discrete gain medium rather than a portion of optical fiber 16 to generate the gain. In such a case, the gain medium would be connected or coupled in series with fiber 16, at an appropriate position along the transmission path.

As shown in FIG. 2, optical amplifier 20 also includes a tunable pump source 26 and a coupler 28. Tunable pump source 26 is coupled to optical fiber 16 (and, therefore, the transmission path between nodes 12 and 14), which, in this case, is the gain medium, via coupler 28.

Tunable pump source 26 is preferably a suitable high power tunable laser. Typical tunable lasers that may be used as tunable pump source 26 include semiconductor lasers and fiber lasers. In the case of a semiconductor laser, tunable pump source 26 may be arranged such that tuning is provided by a resonant cavity that is varied, an array of lasers and a mechanism used to switch between them, or a single laser with many modes. Tunable pump source 26 is preferably tunable over a broad range of frequencies that correspond to pumping frequencies for the frequencies of the optical signals that will travel in the optical communication system 10, as described in more detail below.

Generally speaking, Raman amplifiers may be either co-propagating or counter-propagating, indicating that the pumping energy is transmitted in the same or opposite direction as the signal, respectively. In this embodiment, optical amplifier 20 is preferably a counter-propagating pump, although a co-propagating pump will also be effective.

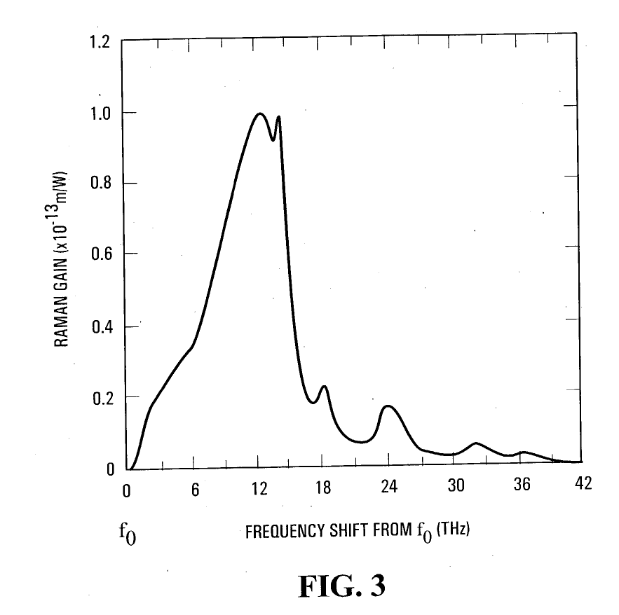

In order to illustrate the relationship between the frequency of tunable pump source 26 and the frequency of the optical signal amplified, a typical gain spectrum for a Raman amplifier using a particular type of fused silica fiber as the gain medium and at a predetermined pumping energy frequency (f₀) is shown in FIG. 3. As illustrated, the gain spectrum for a particular pumping energy frequency f₀ is such that the largest gain (most amplification) occurs in optical signals that have a lower frequency (longer wavelength) than the pumping energy frequency, with a peak at approximately 13 THz from the pumping energy frequency f₀.

Although the Raman gain is spread over a wide range of frequencies (approximately 40 THz), it can also be seen in FIG. 3 that the bandwidth of the effective gain region is somewhat limited, for example, the 3 dB bandwidth is only about 8 THz. However, even though the gain bandwidth is somewhat limited, Raman gain can be generated in silica fiber at a wide range of frequencies in dependence on the pumping energy frequency (f₀) applied. As such, although the Raman gain coefficient (i.e. the amount of gain) is dependent on frequency, a Raman gain spectrum that is similar to that shown in FIG. 3 can be shifted to an arbitrary range of frequencies by adjusting the pumping energy frequency, f₀.

Returning to FIG. 2, coupler 28 may be formed from various devices such as circulators, wavelength division multiplexers, polarization couplers/splitters, dichroic devices, prisms, detraction gratings, arrayed waveguides, and the like. A wavelength division multiplexer is preferred because of its low loss characteristics. Coupler 28 may be wavelength selective or non-selective (“passive”), may be a fiber or free space device, may be polarization sensitive and may also include various tunable or fixed wavelength filters which may be transmissive or reflective, narrow or broadband, or dichroic. Coupler 28 may also include one or more stages incorporating various combinations of the above to effectively couple tunable pump source 26 to optical fiber 16.

Optical amplifier 20 further includes a control system 30 for adjusting the frequency and/or power of tunable pump source 26. Control system 30 includes an optical splitter 32, a detector 34, and a controller 36. Optical splitter 32, for example, a low ratio tap coupler, is provided downstream of coupler 28 to split a portion of the optical signal passing through optical fiber 16 and pass the portion of the optical signal to detector 34.

Detector 34 is coupled to optical splitter 32 in order to detect a characteristic of the optical signal, such as power, frequency, gain, signal to noise ratio, bit error rate (BER) or signal quality (Q) of individual channels, or the like. Detector 34 may distinguish between channels in the optical signal either optically or electrically. For example, depending on the characteristic to be detected, detector 34 may be an optical spectrum analyzer which uses a wavelength selective component to separate and detect different optical wavelengths. This detection allows measurement of an optical power, gain or optical signal-to-noise ratio spectra. Alternatively, detector 34 may use a frequency selective component to select a single channel and then use a broadband electrical receiver to determine BER or Q of the data that is carried on that channel.

Detector 34 is in communication with controller 36 and passes information regarding the characteristic of the optical signal to controller 36 which may then control or adjust the frequency or power of tunable pump source 26, in a manner exemplary of an embodiment of the present invention, according to the characteristic so that the most appropriate gain for the optical signal is provided. Note that, detector 34 and controller 36 do not necessarily need to be co-located as long as there is an appropriate communication path between them.

Controller 36 may, for example, be a processor or computer under software control provided for analyzing or reacting to the input from detector 34 and for appropriately adjusting tunable pump source 26 to amplify the optical signal as described below. Controller 36 may control tunable pump source 26 by, for example, adjusting either or both of frequency and power. For example, pump power may be adjusted by controlling a flow of current to tunable pump source 26 while frequency may be controlled by adjusting a MEMS (Micro Electromechanical System) mirror included in tunable pump source 26.

In operation, controller 36 controls tunable pump source 26 to amplify an optical signal across a desired range of frequencies to optimize a characteristic of the optical signal. The desired range of frequencies and the characteristic to be optimized may be assessed by detector 34. For example, detector 34 may assess the frequencies present in the optical signal (optical signal spectrum), in the absence of any amplification, and provide an indication of these frequencies to controller 36. Detector 34 or controller 36 may, in turn, determine or calculate one or more optimal amplification frequencies and powers for the operation of tunable pump source 26 in order to amplify the desired range of frequencies of the optical signal. Alternatively, the desired range of frequencies could optionally be provided manually to controller 36 or detector 34, for example, through a keypad or the like.

Thereafter, detector 34 may assess the characteristic to be optimized and further adjustments may be made. In particular, controller 36 may control the frequency and/or power of tunable pump source 26 such that the gain spectrum provided by tunable pump source 26 in the desired range of frequencies is optimized. For example, controller 36 may tune tunable pump source 26 in power or frequency (e.g. continuously up or down) until the intensity of the optical signal reaches at least a local maximum at a particular frequency in the desired range of frequencies. Alternatively, controller 36 may simply determine, using a calculation or a table look-up or the like, which pump frequency and power combination provides an optimum gain spectrum for the desired range of frequencies of the optical signal. Controller 36 may then control tunable pump source 26 to operate at the determined frequency and power.

As the above examples illustrate, control system 30 may be an open loop or closed loop system. For example, in an open loop system, detector 34 may only check the frequency of the optical signal either once or irregularly when controlled by controller 36 to do so. Controller 36 may then perform a one time adjustment of tunable pump source 26 to output pumping energy at a frequency and with appropriate power (energy) that will provide optimum gain for the detected frequency of the optical signal. In this situation, optical splitter 32 and detector 34 could be placed up or downstream of coupler 28. In a closed loop system, detector 34 may provide on-going readings of a characteristic of the optical signal at a given frequency to controller 36 so that controller 36 may continuously update the operating frequency and/or power of tunable pump source 26 to maintain the characteristic of the optical signal at an optimum level, for the desired frequency. Preferably, tunable pump source 26 is adjusted in a closed loop manner in order to allow for situations in which channels may be added or deleted from the optical signal, channel powers or target frequencies may be changed based on a desired performance of a channel, tunable pump source 26 may vary with temperature or aging or the like.

As described above, in a conventional system, it is generally necessary to use a specific laser for a specific combination of optical fiber and optical signals that will travel through the optical fiber, dependent on system parameters. However, by using tunable pump source 26 and control system 30, it is possible to adjust tunable pump source 26 as required to provide a desired gain spectrum, without explicit knowledge of the requirements of the optical fiber and/or optical signals. Conveniently, amplifier 20 may be installed without regard to parameters of system 10 (FIG. 1). A single amplifier 20 may be used with multiple systems. Open or closed loop control may be used by control system 30 to provide optimal amplification.

In a situation in which the desired range of frequencies to be amplified is broader than the range that can be optically amplified by setting a single tunable pump source 26, controller 36 may adjust or tune tunable pump source 26 to periodically provide pumping energy at a plurality of frequencies so that gain is provided at a plurality of frequency ranges by a single tunable pump source 26. In particular, the operating frequency or power of tunable pump source 26 may be altered in time, providing amplification at desired frequency ranges for a fraction of time. Controller 36 may for example, cause tunable pump source 26 to provide pump energy at detected WDM frequencies for equal periods of time. In effect, tunable pump source 26 replaces multiple pump sources.

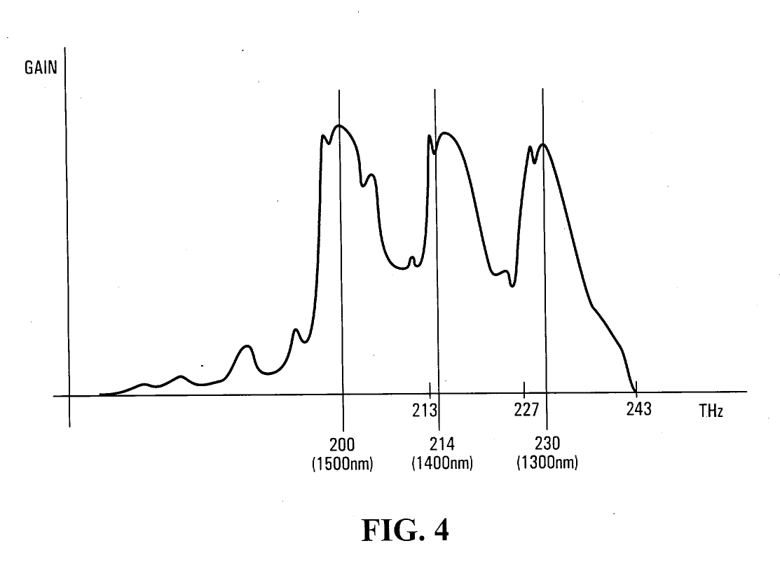

FIG. 4 illustrates an approximate example gain spectrum resulting from discrete scanning of tunable pump source 26 among three desired frequencies. The gain spectrum of FIG. 4 results from controller 36 controlling tunable pump source 26 to cycle between example pump frequencies of 243 THz, 227 THz, and 213 THz (corresponding to optical signals at 230, 214, and 200 THz respectively) pausing at each frequency for a predetermined time and then repeating the cycle periodically. Preferably the cycle or scan is repeated at a frequency of approximately greater than several 100 kHz in order to minimize pump to signal noise transfer. The example gain spectrum shown in FIG. 4, suitably amplifies WDM channels centered at approximately 200, 214, and 230 THz. Optical signals at these optical signal frequencies will be amplified during each scan of the pumping energy frequency such that, over time, each optical signal will be amplified at an average level that is related to the amount of time that the optical signal is within the Raman gain spectrum of the pumping energy. Again, open or closed loop control may be used to provide a desired gain spectrum at or near these desired frequencies. Closed loop control, for example, may be used to vary the scanning rate to provide varied or constant gain at each frequency of interest. As a further alternative, tunable pump source 26 may scan at a fixed rate but the power may be varied during the scan to adjust the gain spectrum to an appropriate level. Still further, it will be understood by one of skill in the art that either or both of the power and frequency of tunable pump source 26 may be varied as necessary in order to allow for variation in the Raman gain spectrum due to changes in pump frequency.

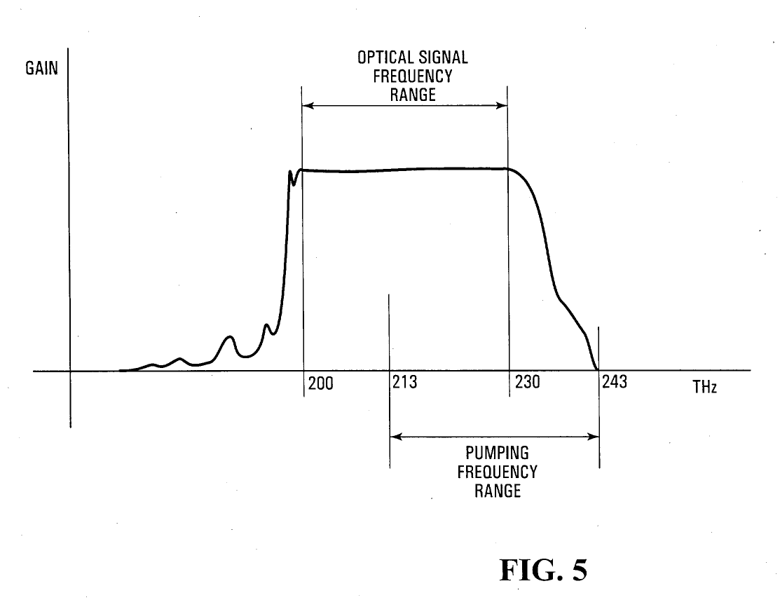

As a further alternative, controller 36 may control tunable pump source 26 to continuously scan a pumping frequency range, between an upper and lower bound, to provide amplification of a corresponding frequency range of optical signals. As above, the power of tunable pump source 26 may also be adjusted as required. FIG. 5 illustrates an approximate example gain spectrum resulting from continuous scanning and also showing the corresponding optical signal frequency range.

Again, open or closed loop control may be used. If desired, closed loop control may be used to increase or decrease the rate of change of frequencies or the power to provide a flat gain profile between the upper and lower frequencies. Alternatively, if a gain profile having another shape is desired, controller 36 may control a scan rate or power of tunable pump source 26 to provide the desired profile.

The scanning of a single tunable pump source 26, discretely or continuously, provides several benefits. For example, problems such as four wave mixing and pump interactions can be reduced significantly. As a single pump source provides pump energy across the whole desired range of frequencies, multiple pumps are not needed and do not interfere with each other. In particular, a single pump source eliminates the problem of having higher frequency pumps provide Raman pumping of lower frequency pumps. Using a single scanned pump also eliminates the problem of requiring a lossy pump multiplexer which is generally used in the case of multiple pumps. Thus, a single scan pump is more efficient in terms of power.

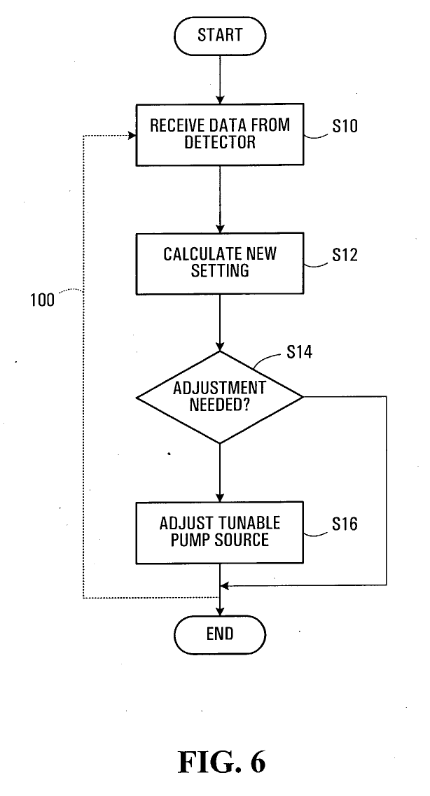

FIG. 6 is a flow chart of an exemplary operation of controller 36. Controller 36 first receives data regarding a characteristic of the optical signal from detector 34 (s10), and then determines new settings for tunable pump source 26 based on the data (s12). For example, detector 34 may determine the optical spectrum of the optical signal and controller 36 may determine a pump signal frequency range and power spectrum to provide a gain spectrum which gives optimal amplification across the full spectrum of the optical signal. Next, controller 36 determines if the new settings are different from the previous settings, indicating that an adjustment is needed (s14). Continuing the example, if an optical signal or a range of optical signals (i.e. one or more wavelengths) have been added in the optical spectrum, the settings may need to be changed to adjust the gain spectrum so that the new channel or channels are also provided with optimal amplification. If an adjustment is needed at s14, controller 36 adjusts tunable pump source 26 (s16). If no adjustment is needed at s14, controller 36 will skip the adjustment at s16. In the case of open loop control, the procedure will then end until initiated again in the future. In the case of closed loop control, the procedure would then loop back to receive new data from detector 34 at s10, as shown by the dotted line 100.

As described above, the adjustment needed for tunable pump source 26 may be determined in a variety of ways. For example, the adjustment may be based on a table look-up provided within controller 36 that relates pump frequencies and powers to optical frequencies amplified and/or other characteristics. Alternatively, the adjustment may be based on a calculation which may also take into account factors such as the optical fiber material, the frequency/wavelength spectrum of the optical signal traveling on the optical fiber, length of fiber, desired settings, or the like, some of which may be determined by detector 34 and some of which may be input to processor 36.

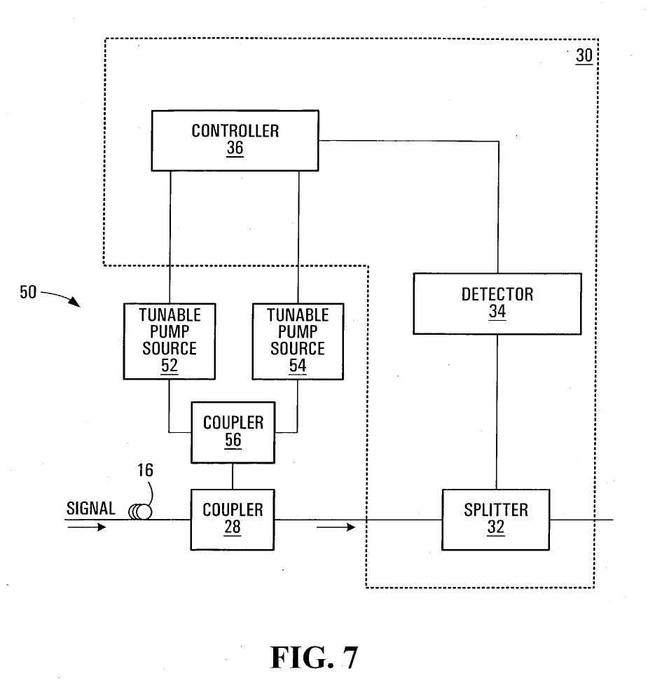

FIG. 7 illustrates an optical amplifier 50 exemplary of another embodiment of the invention. Optical amplifier 50 is similar to optical amplifier 20 of FIG. 2 and similar reference numbers will be used to represent similar elements. In FIG. 7, optical amplifier 50 includes two tunable pump sources 52 and 54 to provide the pumping energy. In this embodiment, tunable pump sources 52 and 54 are each similar to tunable pump source 26. Tunable pump sources 52 and 54 pass through a coupler 56 that combines their energies for insertion into optical transmission path 16. In this case, the provision of two tunable pump sources 52 and 54 allows the frequency and power of each tunable pump source 52 and 54 to be set such that it amplifies a particular bandwidth of the optical signal so that the overall amplified bandwidth is larger. For example, in a situation where there are two WDM bands in optical fiber 16, one centered at approximately 200 THz and the other centered at approximately 230 THz, tunable pump source 52 may provide pumping energy at 213 THz to amplify optical signals in the region of 200 THz whereas tunable pump source 54 may provide pumping energy at 243 THz to amplify optical signals in the region of 230 THz. As above, tunable pump sources may be discretely or continuously scanned to provide optimal amplification of a range of optical signals.

In optical amplifier 50, tunable pump sources 52 and 54 can be adjusted with respect to each other in such a way that certain adverse affects such as four wave mixing, and uneven gain are reduced or avoided. For example, in order to avoid four wave mixing detector 34 can be configured to detect BER or signal Q and processor 36 can then use a search algorithm or the like to adjust frequency ranges and power of tunable pump sources 52 and 54 to provide optimal BER or signal Q.

The ability to tune or scan the frequency of tunable pump sources 52 and 54 provides an additional degree of freedom in optimizing the gain spectrum and in minimizing gain ripple, pump interactions (i.e. FWM or the like) or the like. It will be understood that similar considerations may also be applied to optical amplifiers having more than two tunable pump sources.

In the embodiments above, it will be understood that various modifications are possible. For example, the illustrated embodiments include a separate splitter 32 and detector 34 whereas, in practice, these elements may be combined into one detector unit (not shown). Similarly, controller 36 may be combined with either or both of detector 34 or tunable pump source 26 or the like depending on the required configuration. Further, as indicated above, the optical amplifier 20 may be co-propagating or counter-propagating, may be distributed or discrete, and may include one or more tunable pump sources.

It will also be understood that various elements, and in particular, controller 36, may be implemented as computer executable instructions (a computer program or software) on a computer readable medium that are performed by a processor to implement various desired functions.

It will be further understood that the invention is not limited to the embodiments described herein which are merely illustrative of preferred embodiments of carrying out the invention, and which are susceptible to modification of form, arrangement of parts, steps, details and order of operation. The invention, rather, is intended to encompass all such modification within its scope, as defined by the claims.

What is claimed is:

1. An optical amplifier for amplifying an optical signal along a transmission path, said amplifier comprising:
a tunable pump laser, tunable over a predetermined frequency range;
a gain medium along said transmission path;
a coupler for optically coupling said tunable laser to said gain medium;
a detector to detect at least one characteristic of said optical signal;
an optical splitter to provide at least a portion of said optical signal to said detector; and
a controller for controlling a frequency of said tunable pump laser, said controller in communication with said detector and operable to control said frequency of said tunable pump laser based on said at least one characteristic to provide controlled amplification of said optical signal.

2. The optical amplifier of claim 2, wherein said controller further controls an operating power of said tunable pump laser.

3. The optical amplifier of claim 1, wherein:
said optical signal comprises a plurality of optical signals at different frequencies within an optical signal frequency range; and
wherein said controller is further operable to periodically vary a frequency of said tunable pump source over a pumping frequency range related to said optical signal frequency range.

4. The optical amplifier of claim 3, wherein said frequency of said tunable pump source is varied in discrete steps related to said different frequencies of said plurality of optical channels.

5. The optical amplifier of claim 3, wherein said frequency of said tunable pump source is continuously scanned between a lower frequency bound and an upper frequency bound related to said optical signal frequency range.

6. The optical amplifier of claim 3, wherein said control system also controls a power of said tunable pump source to provide optimal amplification to said optical signals based on said at least one characteristic.

7. The optical amplifier of claim 1, wherein said gain medium comprises silica optical fiber.

8. The optical amplifier of claim 7, wherein said optical fiber connects a transmitter and a receiver in an optical communications system.

9. An optical amplifier for amplifying optical signals along a transmission path, said optical amplifier comprising:
a tunable laser, tunable over at least a scanning frequency range that is related to amplification of frequencies of said optical signals;
a gain medium along said transmission path, for receiving optical energy from said tunable laser and providing said optical energy to said optical signals;
a coupler for coupling said tunable laser to said gain medium; and
a control system for controlling a frequency of said tunable laser to periodically scan over said scanning frequency range.

10. The optical amplifier of claim 9, wherein said control system controls said tunable pump source to periodically scan over said scanning frequency range in discrete steps that are related to said frequencies of said optical signals.

11. The optical amplifier of claim 9, wherein said control system also controls a power of said tunable pump source to provide optimal amplification to said optical signals.

12. The optical amplifier of claim 9, wherein said control system comprises:
an optical splitter for splitting off a portion of said optical signals;
a detector for detecting said frequencies of said optical signals; and
a controller for determining said scanning frequency range for said tunable laser based on said frequencies of said optical signals and for controlling said frequency of said tunable laser.

13. A method of optically amplifying optical signals, said method comprising:
determining frequencies of at least selected signals of said optical signals;
determining a pumping frequency range for amplifying said selected signals; and
controlling a tunable pump source optically connected with said optical signals to periodically scan over said pumping frequency range.

14. The method of claim 13, wherein said controlling comprises controlling said tunable pump source to periodically scan across said pumping frequency range in discrete steps that are related to said frequencies of said selected signals.

15. The method of claim 13, further comprising detecting at least one characteristic of said optical signals and wherein said controlling further comprises tuning pump power to optimize said at least one characteristic of said optical signals.

16. The method of claim 15, wherein said at least one characteristic of said optical signals is selected from the group consisting of power, frequency, gain, signal-to-noise ratio, bit error rate, or quality.

17. An optical amplifier for amplifying an optical signal along a transmission path, said amplifier comprising:
a first tunable laser, which is tunable over a first predetermined frequency range;
a second tunable laser, which is tunable over a second predetermined frequency range;
a gain medium along said transmission path;
a coupler for optically coupling said first tunable laser and said second tunable laser to said gain medium;
a detector to detect at least one characteristic of said optical signal;
an optical splitter to provide at least a portion of said optical signal to said detector; and
a controller for controlling frequencies of said first tunable laser and said second tunable laser, said controller in communication with said detector and operable to control said frequencies of said first tunable laser and said second tunable laser based on said at least one characteristic to provide controlled amplification of said optical signal.

18. The optical amplifier of claim 17, wherein said controller further controls an operating power of said first tunable laser and said second tunable laser.

19. A computer readable medium containing computer executable instructions for optically amplifying optical signals, which, when operating in a processor, cause the processor to perform the functions of:
determining frequencies of at least selected signals of said optical signals;
determining a pumping frequency range for amplifying said selected signals; and
controlling a tunable pump source optically connected with said optical signals to periodically scan over said pumping frequency range.

20. The computer readable medium of claim 19, wherein said controlling comprises controlling said tunable pump source to periodically scan across said pumping frequency range in discrete steps that are related to said frequencies of said selected signals.
